(19) United States
(12) Patent Application Publication
(10) Pub. No.: US 2010/0238202 A1
(43) Pub. Date: Sep. 23, 2010

(54) Display Device and Method for Driving the same

(75) Inventors: Chih-Cheng Chan, Hsinchu (TW); Sheng-Wen Cheng, Hsinchu (TW)

Correspondence Address: Portal IPR Services, P.O. Box 223205, Chantilly, VA, 20153, US

(73) Assignee: AU Optronics Corp.

(21) Appl. No.: 12/609,242

(22) Filed: Oct. 30, 2009

(30) Foreign Application Priority Data
Mar. 23, 2009 (TW) 098109400

(51) Int. Cl. G09G 5/10

(52) U.S. Cl. 345/690

(57) ABSTRACT

An exemplary method for driving a display device is provided. At least one set of input signals is received. Finding the original signals being the same with the input signals in the signal transforming table is executed. The pixel driving signals is outputted. If at least one of the found second and third original signals is equal to zero, and the found first original signal is equal to neither zero nor maximal gray scale, at least one of the outputted second and third sub-pixel driving signals, and the outputted fourth sub-pixel driving signal are equal to zero. Then, at least one of the pixels of the pixel array is driven by the outputted pixel driving signals. The input signals is transformed into the pixel driving signals by use of the signal transforming table, thereby saving the cost and improving the displaying quality.

This application claims priority to a Taiwan application No. 098109400 filed Mar. 23, 2009.

### BACKGROUND

1. Field of the Invention

The present invention relates to a display device and a method for driving the same, and particularly to a display device with four primary color pixels and a method for driving the same.

2. Description of the Related Art

In recent years, flat panel displays have attracted much attention. The flat panel displays such as liquid crystal displays (LCDs), plasma display panels (PDPs), organic electro-luminescence displays (OELDs), and so on, have the advantages of lightness, thinness, smallness, low heat production, low electric power consumption, and non-radiation. Therefore, the growth of the flat panel displays in the consumption market is amazing.

It is known that a typical color display device usually includes a number of pixels. Generally, each of the pixels is comprised of a red sub-pixel, a blue sub-pixel, and a green sub-pixel. In order to increase the brightness of the display panel of the color display device without increasing the power consumption thereof, the display device with four primary color pixels has developed. The display device with four primary color pixels is evolved from the typical color display device by adding a white sub-pixel into each of the pixels. The white sub-pixel is capable of increasing brightness, contrast and transmittance of the display panel.

However, nowadays, the image signals outputted by electronic devices only include a number of signals for driving the red sub-pixel, the blue sub-pixel, and the green sub-pixel. Therefore, it is necessary to transform the signals for driving the red sub-pixel, the blue sub-pixel, and the green sub-pixel into the signals for driving the red sub-pixel, the blue sub-pixel, the green sub-pixel and white sub-pixel by a signal transforming method. Thus, the transformed driving signals can drive the red sub-pixel, the blue sub-pixel, the green sub-pixel and white sub-pixel.

A typical signal transforming method generally includes the following steps. Firstly, the received driving signal for driving the red sub-pixel, the blue sub-pixel, and the green sub-pixel is multiplied by a respective amplification coefficient. The amplification coefficient can either be a fixed value or a variable value. Thus, the received driving signal for driving the red sub-pixel, the blue sub-pixel, and the green sub-pixel is amplified. Secondly, a driving signal for driving the white sub-pixel is extracted from the amplified driving signal for driving the red sub-pixel, the blue sub-pixel, and the green sub-pixel. Thus, the transformed driving signal for driving the red sub-pixel, the blue sub-pixel, the green sub-pixel and white sub-pixel is obtained. However, because of difference of the signals for driving the red sub-pixel, the blue sub-pixel, and the green sub-pixel received by the display device, it is necessary to choose the different amplification coefficients correspondingly. It is also necessary for the extraction method about the driving signal for driving the white sub-pixel to be different correspondingly. If either the amplification coefficient or the extraction method is not proper to be used, the improper transformation of the driving signals will affect the displaying image to have some defects such as poor tone value and insufficient brightness.

Therefore, what is needed is a display device that is capable of transforming the received signals for driving three primary colors into the signals for driving four primary colors, thereby displaying a high quality image according to the outputted signals for driving four primary colors.

Therefore, what is needed is a method for transforming the received signals for driving three primary colors into the signals for driving four primary colors in the manner of look-up table, thereby displaying a high quality image according to the outputted signals for driving four primary colors.

### BRIEF SUMMARY

The present invention is directed to a display device for transforming the received driving signals used for driving three primary colors pixels to the driving signals used for driving four primary colors pixels without decreasing display quality.

The present invention is also directed to a method for driving the display device. The method can transform the received driving signals used for driving three primary colors pixels to the driving signals used for driving four primary colors pixels by looking up in table without decreasing display quality.

The present invention provides a display device including a pixel array, a signal receiving module, a storage module, a looking-up module, a signal output module, and a driving module. The pixel array includes a number of pixels. Each of the pixels includes a number of sub-pixels. The storage module is configured for storing a signal transforming table. The signal transforming table includes a number of sets of original signals and a number of sets of pixel driving signals. Each set of original signals corresponds to one set of pixel driving signals and includes a first original signal, a second original signal and a third original signal. The corresponding one set of pixel driving signal includes a first sub-pixel driving signal corresponding to the first original signal, a second sub-pixel driving signal corresponding to the second original signal, a third sub-pixel driving signal corresponding to the third original signal and a fourth sub-pixel driving signal. When at least one of the second original signal and the third original signal of one set of original signals is equal to zero and the first original signal of the set of original signals is equal to neither zero nor maximal gray scale in the signal transforming table, at least one of the second sub-pixel driving signal and the third sub-pixel driving signal of one set of pixel driving signals corresponding to the set of original signals is equal to zero, and the fourth sub-pixel driving signal of the set of pixel driving signals is also equal to zero.

In addition, the signal receiving module is configured for receiving at least one set of input signals. The look-up module is configured for finding at least one set of original signals being the same with the at least one set of input signals in the signal transforming table. The signal output module is configured for outputting at least one set of pixel driving signals corresponding to the at least one set of original signals. The driving module is configured for driving at least one of the pixels of the pixel array with the at least one set of pixel driving signals.

The present invention also provides a display device including a pixel array, a signal receiving module, a storage module, a looking-up module, a signal output module, and a driving module. The pixel array includes a number of pixels. Each of the pixels includes a number of sub-pixels. The storage module is configured for storing a signal transforming table. The signal transforming table includes a number of sets of original signals and a number of sets of pixel driving signals. Each set of original signals corresponds to one set of pixel driving signals and includes a first original signal, a second original signal and a third original signal. The corresponding one set of pixel driving signal includes a first sub-pixel driving signal corresponding to the first original signal, a second sub-pixel driving signal corresponding to the second original signal, a third sub-pixel driving signal corresponding to the third original signal and a fourth sub-pixel driving signal. When the first original signal, the second original signal and the third original signal of one set of original signals are unequal to zero, the first original signal and the second original signal of the set of original signals are respectively identical to the first original signal and the second original signal of the other one set of original signals in the signal transforming table, and the third original signal of the set of original signals is more than a second predetermined value, the third sub-pixel driving signal of one set of pixel driving signals corresponding to the set of original signals is either more than or equal to the third original signal of the set of original signals.

In addition, the signal receiving module is configured for receiving at least one set of input signals. The look-up module is configured for finding at least one set of original signals being the same with the at least one set of input signals in the signal transforming table. The signal output module is configured for outputting at least one set of pixel driving signals corresponding to the at least one set of original signals. The driving module is configured for driving at least one of the pixels of the pixel array with the at least one set of pixel driving signals.

The present invention also provides a display device including a pixel array, a signal receiving module, a storage module, a looking-up module, a signal output module, and a driving module. The pixel array includes a number of pixels. Each of the pixels includes a number of sub-pixels. The storage module is configured for storing a signal transforming table. The signal transforming table includes a number of sets of original signals and a number of sets of pixel driving signals. Each set of original signals corresponds to one set of pixel driving signals and includes a first original signal, a second original signal and a third original signal. The corresponding one set of pixel driving signal includes a first sub-pixel driving signal corresponding to the first original signal, a second sub-pixel driving signal corresponding to the second original signal, a third sub-pixel driving signal corresponding to the third original signal and a fourth sub-pixel driving signal. When the first original signal, the second original signal and the third original signal of one set of original signals are unequal to zero, the first original signal and the second original signal of the set of original signals are respectively identical to the first original signal and the second original signal of the other one set of original signals in the signal transforming table, and the third original signal of the set of original signals is less than a second predetermined value, the third sub-pixel driving signal of one set of pixel driving signals corresponding to the set of original signals is either less than or equal to the third original signal of the set of original signals.

In addition, the signal receiving module is configured for receiving at least one set of input signals. The look-up module is configured for finding at least one set of original signals being the same with the at least one set of input signals in the signal transforming table. The signal output module is configured for outputting at least one set of pixel driving signals corresponding to the at least one set of original signals. The driving module is configured for driving at least one of the pixels of the pixel array with the at least one set of pixel driving signals.

The display device provided by the present invention includes a pixel array. Each of the pixels of the pixel array includes a red sub-pixel, a green sub-pixel, a blue sub-pixel and a white sub-pixel.

Moreover, in the present invention, the first sub-pixel driving signal, the second sub-pixel driving signal and the third sub-pixel driving signal of the at least one set of pixel driving signals outputted by the signal output module are respectively configured for driving one of the red sub-pixel, the green sub-pixel and the blue sub-pixel, and the fourth sub-pixel driving signal of the at least one set of pixel driving signals outputted by the signal output module is configured for driving the white sub-pixel.

The display device provided by the present invention includes a calculating module. The calculating module is configured for calculating at least one set of output signals with the at least one set of input signals by use of an interpolation method according to the signal transforming table.

Further, the signal output module is configured for outputting the at least one set of output signals, and the driving module is configured for driving at least one of the pixels of the pixel array with the at least one of output signals.

Further, the present invention provides a method for driving a display device storing the aforementioned signal transforming table therein. The display device includes a pixel array with a number of pixels. Each of the pixels includes a number of sub-pixels. The method includes the following steps. Firstly, at least one set of input signals is received. Secondly, at least one set of original signals in the signal transforming table is found, wherein when the at least one set of original signals being the same with the at least one set of input signals is found, the following steps are executed. Firstly, at least one set of pixel driving signals corresponding to the at least set of original signals is outputted. Then, at least one of the pixels of the pixel array is driven by the outputted at least one set of pixel driving signals. If at least one of the second original signal and the third original signal of the found at least one of original signals is equal to zero, and the first original signal of the found at least one of original signals is equal to neither zero nor the maximal gray scale, at least one of the second sub-pixel driving signal and the third sub-pixel driving signal of the outputted at least one set of pixel driving signals is equal to zero and the fourth sub-pixel of the outputted at least one set of pixel driving signals is equal to zero.

The present invention also provides a method for driving a display device storing the aforementioned signal transforming table therein. The display device includes a pixel array with a number of pixels. Each of the pixels includes a number of sub-pixels. The method includes the following steps. Firstly, at least one set of input signals is received. Secondly, at least one set of original signals in the signal transforming table is found, wherein when the at least one set of original signals being the same with the at least one set of input signals is found, the following steps are executed. Firstly, at least one set of pixel driving signals corresponding to the at least set of original signals is outputted. Then, at least one of the pixels of the pixel array is driven by the outputted at least one set of pixel driving signals. If the first original signal, the second original signal and the third original signal of the found at least one of original signals are unequal to zero, the first original signal and the second original signal of the found at least one of original signals are respectively identical to the first original signal and the second original signal of the other one set of original signals in the signal transforming table, and the third original signal of the found one set of original signals is more than a second predetermined value, the third sub-pixel driving signal of the outputted one set of pixel driving signals corresponding to the found one set of original signals is either more than or equal to the third original signal of the found one set of original signals.

The present invention also provides a method for driving a display device storing the aforementioned signal transforming table therein. The display device includes a pixel array with a number of pixels. Each of the pixels includes a number of sub-pixels. The method includes the following steps. Firstly, at least one set of input signals is received. Secondly, at least one set of original signals in the signal transforming table is found, wherein when the at least one set of original signals being the same with the at least one set of input signals is found, the following steps are executed. Firstly, at least one set of pixel driving signals corresponding to the at least set of original signals is outputted. Then, at least one of the pixels of the pixel array is driven by the outputted at least one set of pixel driving signals. If the first original signal, the second original signal and the third original signal of the found at least one of original signals are unequal to zero, the first original signal and the second original signal of the found at least one of original signals are respectively identical to the first original signal and the second original signal of the other one set of original signals in the signal transforming table, and the third original signal of the found one set of original signals is less than a second predetermined value, the third sub-pixel driving signal of the outputted one set of pixel driving signals corresponding to the found one set of original signals is either less than or equal to the third original signal of the found one set of original signals.

Additionally, in the signal transforming table provided by the present invention, when the second original signal and the third original signal of one set of original signals in the signal transforming table all are equal to zero, the second sub-pixel driving signal and the third sub-pixel driving signal of one set of pixel driving signals corresponding to the set of original signals all are equal to zero and the first sub-pixel driving signal of the set of pixel driving signals corresponding to the set of original signals is equal to the first original signal of the set of original signals.

Also, in the signal transforming table provided by the present invention, when the third original signal of one set of original signals in the signal transforming table is equal to zero and the second original signal of the set of original signals is equal to neither zero nor the maximal gray scale, the first sub-pixel driving signal of one set of pixel driving signals corresponding to the set of original signals is unequal to the first original signal of the set of original signals, the second sub-pixel driving signal of the set of pixel driving signals corresponding to the set of original signals is unequal to the second original signal of the set of original signals.

In the signal transforming table provided by the present invention, when the first original signal of one set of original signals is equal to the second original signal of the set of original signal and is less than a first predetermined value, the first sub-pixel driving signal of one set of pixel driving signals corresponding to the set of original signals is equal to the second sub-pixel driving signal of the set of pixel driving signals corresponding to the set of original signals and is less than the first original signal of the set of original signal.

In signal transforming table provided by the present invention, when the first original signal of the set of original signal is equal to the second original signal of the set of original signal and is more than a first predetermined value, the first sub-pixel driving signal of one set of pixel driving signals corresponding to the set of original signals is equal to the second sub-pixel driving signal of the set of pixel driving signals corresponding to the set of original signals and is more than the first original signal of the set of original signals.

In the method provide by the present invention, when the at least one set of original signals being the same with the at least one set of input signals is not found in the signal transforming table in the step of finding at least one set of original signals in the signal transforming table, the successive steps of the method includes calculating at least one set of output signals with the at least one set of input signals by use of an interpolation method according to the signal transforming table, thereby outputting the at least one of output signals and driving the at least one of the pixels of the pixel array with the outputted at least one of output signals.

The present invention provides a display device that is capable of transforming the received signals for driving three primary color pixels into the signals for driving four primary color pixels in the manner of look-up-table. The transformed signals for driving four primary color pixels drives the display device with four primary color pixels to display image. Therefore, the display device of the present invention can have low cost, thereby facilitating producing a mass of display device with four primary color pixels.

Moreover, when the transformed driving signal for driving four primary color pixels drives the display device to display a pure color image, the pure color tone of the pure color image is identical to the pure color tone of the image displayed by the display device driven by the received original driving signal for driving three primary color pixels. Moreover, the displaying brightness of the pure color image can be adjusted according to the demand. Therefore, the transformed driving signal for driving four primary color pixels can not only maintain the color tone of the image but also improve the displaying quality of the display device.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit block diagram of a display device in accordance with an embodiment of the present invention.

FIG. 2 is a schematic view of an arranging fashion of the sub-pixels in a pixel array in accordance with another embodiment of the present invention.

FIG. 3 is a flow chart of a method for driving the display device in accordance with an embodiment of the present invention.

FIG. 4 is a signal transformation table in accordance with the preferred embodiment of the present invention.

### DETAILED DESCRIPTION

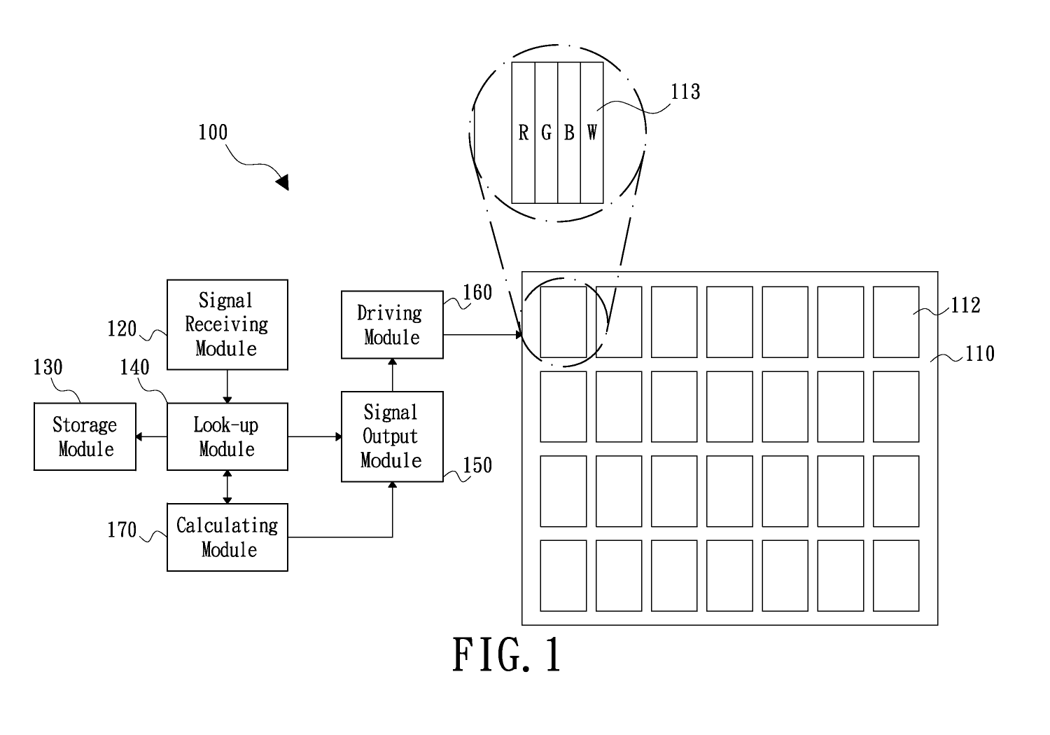

FIG. 1 is a circuit block diagram of a display device in accordance with a preferred embodiment of the present invention. Referring to FIG. 1, the display device 100 includes a pixel array 110, a signal receiving module 120, a storage module 130, a look-up module 140, a signal output module 150 and a driving module 160. The pixel array 110 includes a number of pixels 112. Each of the pixels 112 includes a number of sub-pixels 113. In the present embodiment, each of the pixels 112 includes a red sub-pixel R, a green sub-pixel G, a blue sub-pixel B and a white sub-pixel W. That is, the display device 100 is a four primary color display.

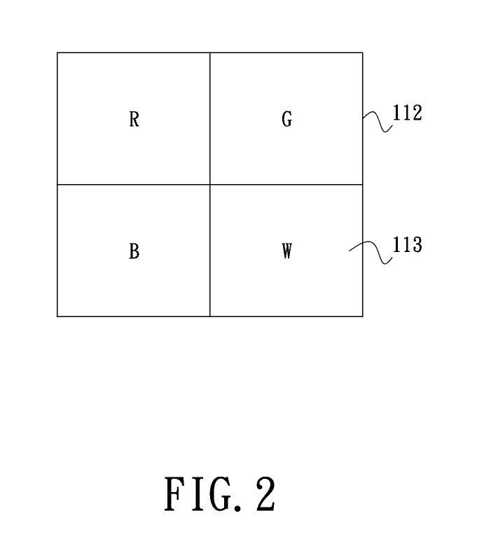

The sub-pixels 113 of each of the pixels 112 can be arranged, but not limited to, in such a manner that the sub-pixels 113 are parallel to each other as shown in FIG. 1. It is noted that the sub-pixels 113 also can be arranged in a matrix as shown in FIG. 2 in accordance with another embodiment of the present invention. Moreover, the arranging order of the sub-pixels 113 is not limited by the arranging order of the sub-pixels 113 shown in FIG. 1 and FIG. 2. The arranging order of the sub-pixels 113 can be changed.

A method for driving the display device 100 will be described in the following paragraphs.

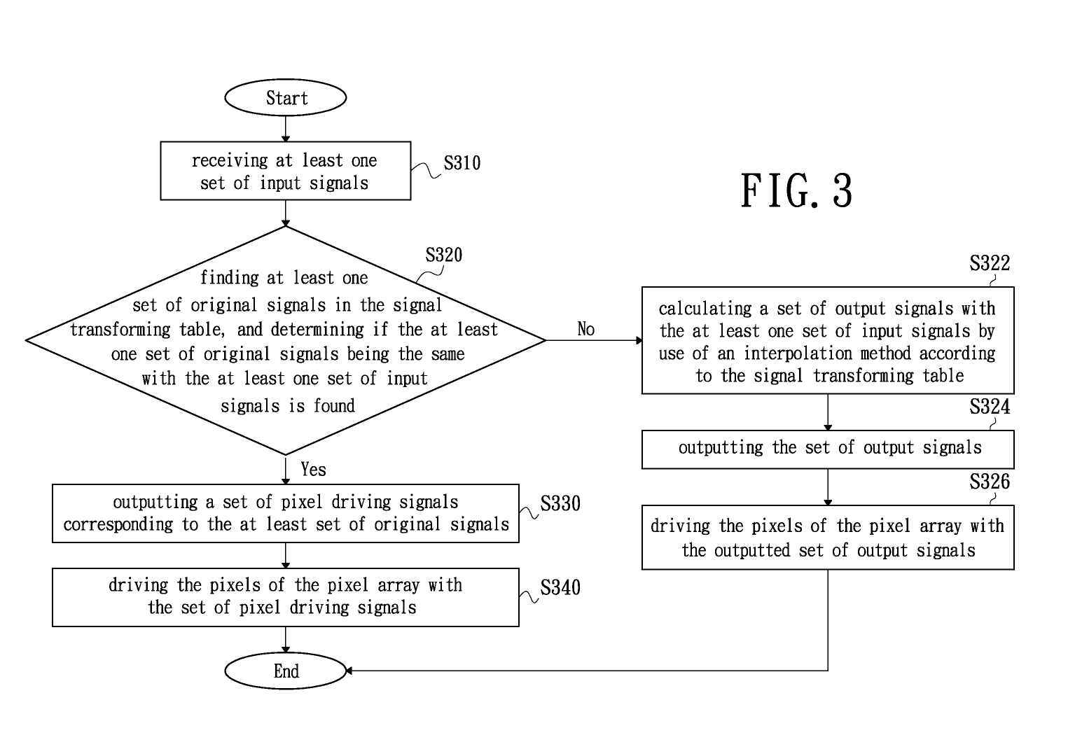

FIG. 3 is a flow chart of a method for driving the display device in accordance with an embodiment of the present invention. Referring to FIG. 1 and FIG. 3, firstly, in the step S310, at least one set of input signals from the external circuit (e.g., computer host (not shown)) is received by the signal receiving module 120. In the present embodiment, the sets of input signals received by the signal receiving module 120 are sets of signals for driving three primary color (R, G, B) pixels outputted from the external circuit.

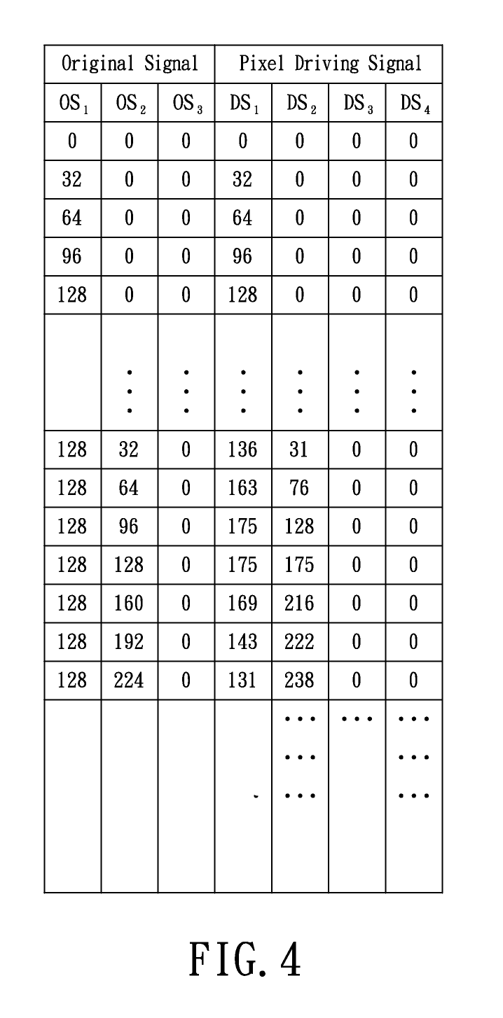

Secondly, in the step S320, a signal transformation table 400 (shown in FIG. 4) stored in the storage module 130 is looked-up by the look-up module 140. The signal transformation table 400 includes a number of sets of original signals and a number of sets of pixel driving signals. The relationship of the sets of original signals and the sets of pixel driving signals will be described in the following description. The look-up module 140 is configured for finding the sets of original signals being the same with the sets of input signals received by the signal receiving module 120 in the signal transformation table 400.

In the present embodiment, the method for generating the signal transformation table 400 includes the following exemplary steps. At first, a number of set of original signals are inputted into an external processor. Then, the external processor obtains a number of sets of pixel driving signals corresponding to the sets of original signals by using an algorithm stored therein. Finally, the signal transformation table 400 is composed of the sets of original signals and the sets of pixel driving signals corresponding to the sets of original signals.

Referring to FIG. 1 and FIG. 3, if the look-up module 140 finds a set of original signals being the same with the set of driving signals received by the signal receiving module 120 in the signal transformation table 400, the step S330 is executed. That is, the set of pixel driving signals corresponding to the found set of original signals is outputted by the signal output module 150. Then, the step S340 is executed, and thus the pixels 112 in the pixel array 110 is driven by the driving module 160 according to the set of pixel driving signals outputted from the signal output module 150.

When the look-up module 140 does not find the set of original signals being the same with the set of pixel driving signals received by the signal receiving module 120 in the signal transformation table 400, the step S322 is executed. That is, an interpolation method is operated according to the signal transformation table 400, thereby a set of output signals corresponding to the set of driving signals received by the signal receiving module 120 is obtained. In the present embodiment, the display device 100 further includes a calculating module 170 configured for calculating the set of output signals.

In detail, when the look-up module 140 does not find at least one set of the original signals being the same with the at least one set of driving signals received by the signal receiving module 120 in the signal transformation table 400, the calculating module 170 will work, thereby the set of output signals corresponding to the set of driving signals received by the signal receiving module 120 is obtained. In the present embodiment, the calculating module 170 will calculate with two sets of original signals approximate to the set of input signals received by the signal receiving module 120 in the signal transformation table 400 and the two sets of pixel driving signals corresponding to the two sets of original signals using the interpolation method. For example, if a set of input signals (128, 48, 0) is received by the signal receiving module 120, the calculating module 170 calculates with two sets of original signals (128, 32, 0) and (128, 48, 0) and two sets of pixel driving signals (136, 31, 0, 0) and (163, 76, 0, 0) corresponding to the two sets of original signals (128, 32, 0) and (128, 48, 0) in the signal transformation table 400 using the interpolation method, thereby a set of output signals is obtained. The interpolation method is a known calculating method and it is not described here.

After the set of output signals corresponding to the set of input signals received by the signal receiving module 120 is obtained, the step S324 is executed. That is, the set of output signals is outputted by the signal output module 150. Then, the step S326 is executed, and thus the pixels 112 in the pixel array 110 is driven by the driving module 160 with the set of output signals from the signal output module 150.

The method for driving the display device 100 can transform the sets of signals for driving three primary color pixels received by the signal receiving module 120 into the sets of signals for driving four primary color pixels in the manner of look-up-table (LUT). The pixels 112 in the pixel array 110 are driven by the sets of signals for driving four primary color pixels. Thus, the display device 100 only needs the storage module 130 for storing the signals transformation table 400 therein, the look-up module 140 for finding and the calculating module 170 for operating a low level calculation using the interpolation method. As a result, the sets of signals for driving three primary color pixels received by the signal receiving module 120 can be transformed into the sets of signals for driving four primary color pixels readily. That is, the display device 100 can finish the transformation of the sets of driving signals without a complicated calculation operated by a high level processor.

The relationship of the sets of original signals and the sets of pixel driving signals corresponding to the sets of original signal in the signal transformation table 400 is now described.

Referring to FIG. 4, each set of original signals corresponds to one set of pixel driving signals. Each set of original signals includes a first original signal OS₁, a second original signal OS₂ and a third original signal OS₃. The corresponding set of pixel driving signals includes a first sub-pixel driving signal DS₁, a second sub-pixel driving signal DS₂, a third sub-pixel driving signal DS₃ and a fourth sub-pixel driving signal DS₄. The first sub-pixel driving signal DS₁ corresponds to the first original signal OS₁. The second sub-pixel driving signal DS₂ corresponds to the second original signal OS₂. The third sub-pixel driving signal DS₃ corresponds to the third original signal OS₃.

The first sub-pixel driving signal DS₁, the second sub-pixel driving signal DS₂ and the third sub-pixel driving signal DS₃ are respectively configured for driving one of the red sub-pixel R, the green sub-pixel G and the blue sub-pixel B. In the present embodiment, the first sub-pixel driving signal DS₁ is configured for driving the red sub-pixel R, the second sub-pixel driving signal DS₂ is configured for driving the green sub-pixel G, and the third sub-pixel driving signal DS₃ is configured for driving the blue sub-pixel B. The fourth sub-pixel driving signal DS₄ is configured for driving the white sub-pixel W.

When at least one of the second original signal OS₂ and the third original signal OS₃ of one set of original signals is equal to zero and the first original signal OS₁ of the set of original signals is equal to neither zero nor the maximal gray scale, at least one of the second sub-pixel driving signal DS₂ and the third sub-pixel driving signal DS₃ of one set of pixel driving signals corresponding to the set of original signals is equal to zero. At the same time, the fourth sub-pixel driving signal DS₄ of the set of pixel driving signals is also equal to zero. Moreover, if both the second original signal OS₂ and the third original signal OS₃ of one set of original signals all are equal to zero and the first original signal OS₁ of the set of original signals is equal to neither zero nor the maximal gray scale, the second sub-pixel driving signal DS₂ and the third sub-pixel driving signal DS₃ of one set of pixel driving signals corresponding to the set of original signals are equal to zero. At the same time, the fourth sub-pixel driving signal DS₄ of the set of pixel driving signals is also equal to zero and the first sub-pixel driving signal DS₁ of the set of pixel driving signals is equal to the first original signal OS₁ of the set of original signals.

It is note that the maximal gray scale refers to a maximal value of the gray scale displayed by the display device 100. For example, if the display device 100 is capable of displaying an image with 256 gray scales, the value of the gray scale is from 0 to 255. Thus, the maximal gray scale is 255.

Referring to FIG. 1 and FIG. 4, if one set of original signals (OS₁, OS₂, OS₃) is (32, 0, 0), the corresponding set of pixel driving signals (DS₁, DS₂, DS₃, DS₄) is (32, 0, 0, 0). In other words, when one set of input signals received by the signal receiving module 120 is (32, 0, 0), the corresponding set of pixel driving signals (32, 0, 0, 0) is found by the look-up module 140 in the signal transformation table 400. Then, at least one of pixels 112 of the pixel array 110 is driven by the driving module 160 with the corresponding set of pixel driving signals (32, 0, 0, 0). In the present embodiment, only the red sub-pixel R of the pixel 112 receives the pixel driving signal to be driven. As a result, the display device 100 displays a red image.

Therefore, when the display device of the present invention receives one set of input signal that only includes the driving signal for driving one color sub-pixel of the four primary color pixels, the transformed set of pixel driving signals in the manner of look-up-table also only includes the corresponding color sub-pixel driving signal capable of being received by the corresponding color sub-pixel. The value of the set of input signal is equal to the transformed set of pixel driving signal.

Additionally, when the first original signal OS₁ and the second original signal OS₂ of one set of original signals is equal to neither zero nor the maximal gray scale and the third original signal OS₃ of the set of original signals is equal to zero, the third sub-pixel driving signal DS₃ and the fourth sub-pixel driving signal DS₄ of one set of pixel driving signals corresponding to the set of original signals are equal to zero, the second sub-pixel driving signal DS₂ of the set of pixel driving signals is unequal to the second original signal OS₂, and the first sub-pixel driving signal DS₁ of the set of pixel driving signals is unequal to the first original signal OS₁.

Further, when the first original signal OS₁ of one set of original signals is equal to the second original signal OS₂ of the set of original signals, and the first original signal OS₁ and the second original signal OS₂ all are less than a first predetermined value, the first sub-pixel driving signal DS₁ of one set of pixel driving signals corresponding to the set of original signals is equal to the second sub-pixel driving signal DS₂ of the set of pixel driving signals, and is less than the first original signal OS₁ of the set of original signals.

For example, the first predetermined value is 100. One set of original signals (OS₁, OS₂, OS₃) is (60, 60, 0), the corresponding set of pixel driving signals (DS₁, DS₂, DS₃, DS₄) is (40, 40, 0, 0). Thus, when one set of input signals received by the signal receiving module 120 is (60, 60, 0), the corresponding set of pixel driving signals (40, 40, 0, 0) is found by the look-up module 140 in the signal transformation table 400. Then, at least one of pixels 112 of the pixel array 110 is driven by the driving module 160 with the corresponding one set of pixel driving signals (40, 40, 0, 0).

In contrast, when the first original signal OS₁ of one set of original signals is equal to the second original signal OS₂ of the set of original signals, and the first original signal OS₁ and the second original signal OS₂ of the set of original signals all are more than the first predetermined value, the first sub-pixel driving signal DS₁ of one set of pixel driving signals corresponding to the set of original signals is equal to the second sub-pixel driving signal DS₂ of the set of pixel driving signals, and the first sub-pixel driving signal DS₁ of the set of pixel driving signals is more than the first original signal OS₁. For example, the first predetermined value is 100. If one set of original signals (OS₁, OS₂, OS₃) is (128, 128, 0), the corresponding set of pixel driving signals (DS₁, DS₂, DS₃, DS₄) is (175, 175, 0, 0).

In the present embodiment, when one set of input signals received by the signal receiving module 120 is (128, 128, 0), the corresponding set of pixel driving signals (175, 175, 0, 0) is found by the look-up module 140 in the signal transformation table 400. The set of input signals (128, 128, 0) is configured for driving the display device 100 to display a yellow image. Then, the driving module 160 drives the red sub-pixel R and the green sub-pixel G of the pixel 112 in the pixel array 110 with the corresponding one set of pixel driving signals (175, 175, 0, 0). The corresponding set of pixel driving signals (175, 175, 0, 0) can also drives the pixel 112 to display the yellow image. At the same time, the displaying brightness of the pixel 112 driven by the corresponding set of pixel driving signals (175, 175, 0, 0) is more than the displaying brightness of the pixel 112 directly driven by the set of input signal (128, 128, 0).

As described above, the display device 100 of the present invention is capable of transforming the received signals for driving three primary color pixels into the signals for driving four primary color pixels. When the signals for driving four primary color pixels drive the pixel 112 of the display device 100, the pure color tone displayed is identical to the original pure color tone to be displayed. Moreover, the transformed signals for driving four primary color pixels can enhance the displaying brightness of the image, thereby improving the displaying quality of the display device 100.

Again, referring to FIG. 1 and FIG. 4, if the first original signal OS₁, the second original signal OS₂ and the third original signal OS₃ of one set of original signals (OSᵢ, OS₂, OS₃) identical to the set of input signals received by the signal receiving module 120 are unequal to zero, and the first original signal OS₁ and the second original signal OS₂ of the set of original signals (OS₁, OS₂, OS₃) are identical to the first original signal and the second original signal of the other one set of original signals in the signal transforming table 400, and the third original signal OS₃ of the set of original signals (OS₁, OS₂, OS₃) is more than a second predetermined value, the third sub-pixel driving signal DS₃ of the set of pixel driving signals (DS₁, DS₂, DS₃, DS₄) corresponding to the set of original signals (OS₁, OS₂, OS₃) is either more than or equal to the third original signal OS₃. In contrast, if the third original signal OS₃ of the set of original signals (OS₁, OS₂, OS₃) is less than a second predetermined value, the third sub-pixel driving signal DS3 of the set of pixel driving signals (DS₁, DS₂, DS₃, DS₄) is either less than or equal to the third original signal OS₃.

For example, the second predetermined value is 150. The first original signal OS1 and the second original signal OS2 all are 128. When one set of input signals received by the signal receiving module 120 is (128, 128, 168), the third sub-pixel driving signal DS3 found by the look-up module 140 in the signal transformation table 400 is 192. In contrast, when the input signal received by the signal receiving module 120 is (128, 128, 96), the third sub-pixel driving signal DS3 found by the look-up module 140 in the signal transformation table 400 is 50.

The present invention relates to a display device that is capable of transforming the signals for driving three primary color pixels into the signals for driving four primary color pixels in the manner of the look-up-table. The transformed signals for driving four primary color pixels drives the display device with four primary color pixels to display image. Therefore, the display device of the present invention can have low cost, thereby facilitating producing a mass of display device with four primary color pixels.

Moreover, when the transformed driving signal for driving four primary color pixels drives of the display device 100 to display a pure color image, the color tone of the pure color image is identical to the color tone of the image that is driven to display by the original signals for driving three primary color pixels. Moreover, the displaying brightness of the color image can be adjusted according to demand. The transformed signals for driving four primary color pixels can not only maintain the color tone of the image but also improve the displaying quality of the display device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for driving a display device having a signal transforming table therein, the display device having a pixel array comprising a plurality of pixels, each of the pixels comprising a plurality of sub-pixels, the signal transforming table comprising a plurality of sets of original signals and a plurality of sets of pixel driving signals, each set of original signals corresponding to one set of pixel driving signals and comprising a first original signal, a second original signal and a third original signal, the corresponding one set of pixel driving signals comprising a first sub-pixel driving signal corresponding to the first original signal, a second sub-pixel driving signal corresponding to the second original signal, a third sub-pixel driving signal corresponding to the third original signal and a fourth sub-pixel driving signal, the method comprising:
receiving at least one set of input signals;
finding at least one set of original signals in the signal transforming table, wherein when the at least one set of original signals being the same with the at least one set of input signals is found, executing the following steps of:
outputting at least one set of pixel driving signals corresponding to the at least one set of original signals; and
driving at least one of the pixels of the pixel array with the at least one set of pixel driving signals;
wherein if at least one of the second original signal and the third original signal of the at least one of original signals is equal to zero, and the first original signal of the at least one of original signals is equal to neither zero nor maximal gray scale, at least one of the second sub-pixel driving signal and the third sub-pixel driving signal of the outputted at least one set of pixel driving signals is equal to zero and the fourth sub-pixel of the outputted at least one set of pixel driving signals driving signal is equal to zero.

2. The method as recited in claim 1, wherein if the second original signal and the third original signal of the at least one of original signals all are equal to zero, the second sub-pixel driving signal and the third sub-pixel driving signal of the outputted at least one set of pixel driving signals all are equal to zero and the first sub-pixel driving signal of the outputted at least one set of pixel driving signals is equal to the first original signal of the at least one of original signals.

3. The method as recited in claim 1, wherein if the third original signal of the at least one of original signals is equal to zero and the second original signal of the at least one of original signals is equal to neither zero nor maximal gray scale, the first sub-pixel driving signal of the outputted at least one set of pixel driving signals is unequal to the first original signal of the at least one of original signals and the second sub-pixel driving signal of the outputted at least one set of pixel driving signals is unequal to the second original signal of the at least one of original signals.

4. The method as recited in claim 3, wherein if the first original signal of the at least one of original signals is equal to the second original signal of the at least one of original signals and is less than a first predetermined value, the first sub-pixel driving signal of the outputted at least one set of pixel driving signals is equal to the second sub-pixel driving signal of the outputted at least one set of pixel driving signals and is less than the first original signal of the found at least one of original signals.

5. The method as recited in claim 3, wherein if the first original signal of the at least one of original signals is equal to the second original signal of the at least one of original signals and is more than a first predetermined value, the first sub-pixel driving signal of the outputted least one set of pixel driving signals is equal to the second sub-pixel driving signal of the outputted at least one set of pixel driving signals and is more than the first original signal.

6. The method as recited in claim 1, wherein each of the pixels comprises a red sub-pixel, a green sub-pixel, a blue sub-pixel and a white sub-pixel, in the step of driving at least one of the pixels of the pixel array with the outputted at least one set of pixel driving signals, the first sub-pixel driving signal, the second sub-pixel driving signal and the third sub-pixel driving signal of the outputted at least one set of pixel driving signals are respectively configured for driving one of the red sub-pixel, the green sub-pixel, and the blue sub-pixel, and the fourth sub-pixel driving signal is configured for driving the white sub-pixel.

7. The method as recited in claim 1, wherein in the step of finding at least one set of original signals in the signal transforming table, when the at least one set of original signals being the same with the at least one set of input signals is not found in the signal transforming table, executing the successive steps comprising:
calculating at least one of output signals with the at least one set of input signals by using an interpolation method according to the signal transforming table, thereby outputting the at least one of output signals; and
driving the at least one of the pixels of the pixel array with the outputted at least one of output signals.

8. A method for driving a display device having a signal transforming table therein, the display device having a pixel array comprising a plurality of pixels, each of the pixels comprising a plurality of sub-pixels, the signal transforming table comprising a plurality of sets of original signals and a plurality of sets of pixel driving signals, each set of original signals corresponding to one set of pixel driving signals and comprising a first original signal, a second original signal and a third original signal, the corresponding one set of pixel driving signals comprising a first sub-pixel driving signal corresponding to the first original signal, a second sub-pixel driving signal corresponding to the second original signal, a third sub-pixel driving signal corresponding to the third original signal and a fourth sub-pixel driving signal, the method comprising:
receiving at least one set of input signals;
finding at least one set of original signals in the signal transforming table, wherein when the at least one set of original signals being the same with the at least one set of input signals is found, executing the following steps of:
outputting at least one set of pixel driving signals corresponding to the at least one set of original signals; and
driving at least one of the pixels of the pixel array with the at least one set of pixel driving signals;
wherein if the first original signal, the second original signal and the third original signal of the at least one set of original signals are unequal to zero, the first original signal and the second original signal of the at least one set of original signals are respectively identical to the first original signal and the second original signal of the other one set of original signals in the signal transforming table, and the third original signal of the at least one set of original signals is more than a second predetermined value, the third sub-pixel driving signal of the outputted at least one set of pixel driving signals is either more than or equal to the third original signal of the at least one of original signals.

9. A method for driving a display device having a signal transforming table therein, the display device having a pixel array comprising a plurality of pixels, each of the pixels comprising a plurality of sub-pixels, the signal transforming table comprising a plurality of sets of original signals and a plurality of sets of pixel driving signals, each set of original signals corresponding to one set of pixel driving signals and comprising a first original signal, a second original signal and a third original signal, the corresponding one set of pixel driving signals comprising a first sub-pixel driving signal corresponding to the first original signal, a second sub-pixel driving signal corresponding to the second original signal, a third sub-pixel driving signal corresponding to the third original signal and a fourth sub-pixel driving signal, the method comprising:
receiving at least one set of input signals;
finding at least one set of original signals in the signal transforming table, wherein when the at least one set of original signals being the same with the at least one set of input signals is found, executing the following steps of:
outputting at least one set of pixel driving signals corresponding to the at least one set of original signals; and
driving at least one of the pixels of the pixel array with the at least one set of pixel driving signals;
wherein if the first original signal, the second original signal and the third original signal of the at least one set of original signals are unequal to zero, the first original signal and the second original signal of the at least one set of original signals are respectively identical to the first original signal and the second original signal of the other one set of original signals in the signal transforming table, and the third original signal of the at least one set of original signals is less than a second predetermined value, the third sub-pixel driving signal of the outputted at least one set of pixel driving signals is either less than or equal to the third original signal of the at least one of original signals.

10. A display device, comprising:
a pixel array comprising a plurality of pixels, each of the pixels comprising a plurality of sub-pixels;
a signal receiving module for receiving at least one set of input signals;
a storage module for storing a signal transforming table, the signal transforming table comprising a plurality of sets of original signals and a plurality of sets of pixel driving signals, each set of original signals corresponding to one set of pixel driving signals and comprising a first original signal, a second original signal and a third original signal, the corresponding one set of pixel driving signal comprising a first sub-pixel driving signal corresponding to the first original signal, a second sub-pixel driving signal corresponding to the second original signal, a third sub-pixel driving signal corresponding to the third original signal and a fourth sub-pixel driving signal, at least one of the second original signal and the third original signal of one set of original signals in the signal transforming table being equal to zero, and the first original signal of the set of original signals being equal to neither zero nor maximal gray scale, at least one of the second sub-pixel driving signal and the third sub-pixel driving signal of one set of pixel driving signals corresponding to the set of original signals and the fourth sub-pixel driving signal of the set of pixel driving signals being equal to zero;
a look-up module for finding at least one set of original signals being the same with the at least one set of input signals in the signal transforming table;
a signal output module for outputting at least one set of pixel driving signals corresponding to the at least one set of original signals; and
a driving module for driving at least one of the pixels of the pixel array with the at least one set of pixel driving signals.

11. The display device as recited in claim 10, wherein the second original signal and the third original signal of one set of original signals in the signal transforming table all are equal to zero, the second sub-pixel driving signal and the third sub-pixel driving signal of one set of pixel driving signals corresponding to the set of original signals all are equal to zero, and the first sub-pixel driving signal of one set of pixel driving signals corresponding to the set of original signals is equal to the first original signal of the set of original signals.

12. The display device as recited in claim 10, wherein when the third original signal of one set of original signals in the signal transforming table is equal to zero and the second original signal of the set of original signals is equal to neither zero nor maximal gray scale, the first sub-pixel driving signal of one set of pixel driving signals corresponding to the set of original signals is unequal to the first original signal of the set of original signals, and the second sub-pixel driving signal of one set of pixel driving signals corresponding to the set of original signals is unequal to the second original signal of the set of original signals.

13. The display device as recited in claim 12, wherein the first original signal of one set of original signals is equal to the second original signal of the set of original signals and is less than a first predetermined value, and the first sub-pixel driving signal of one set of pixel driving signals corresponding to the set of original signals is equal to the second sub-pixel driving signal of the set of pixel driving signals corresponding to the set of original signals and is less than the first original signal of the set of original signals.

14. The display device as recited in claim 12, wherein the first original signal of one set of original signal is equal to the second original signal of the set of original signals and is more than a first predetermined value, and the first sub-pixel driving signal of one set of pixel driving signals corresponding to the set of original signals is equal to the second sub-pixel driving signal of the set of pixel driving signals corresponding to the set of original signals and is more than the first original signal of the set of original signals.

15. The display device as recited in claim 10, wherein each of the pixels comprises a red sub-pixel, a green sub-pixel, a blue sub-pixel and a white sub-pixel.

16. The display device as recited in claim 15, wherein the first sub-pixel driving signal, the second sub-pixel driving signal and the third sub-pixel driving signal of the at least one set of pixel driving signals outputted by the outputting module are respectively configured for driving one of the red sub-pixel, the green sub-pixel, and the blue sub-pixel, and the fourth sub-pixel driving signal of the at least one set of pixel driving signals outputted by the outputting module is configured for driving the white sub-pixel.

17. The display device as recited in claim 10, further comprising a calculating module for calculating at least one set of output signals with the at least one set of input signals according to the signal transforming table by using an interpolation method.

18. The display device as recited in claim 17, wherein the outputting module is further configured for outputting the at least one set of output signals, and the driving module is further configured for driving at least one of the pixels of the pixel array with the at least one of output signals.

19. A display device, comprising:
a pixel array comprising a plurality of pixels, each of the pixels comprising a plurality of sub-pixels;
a signal receiving module for receiving at least one set of input signals;
a storage module for storing a signal transforming table, the signal transforming table comprising a plurality of sets of original signals and a plurality of sets of pixel driving signals, each set of original signals corresponding to one set of pixel driving signals and comprising a first original signal, a second original signal and a third original signal, the corresponding one set of pixel driving signal comprising a first sub-pixel driving signal corresponding to the first original signal, a second sub-pixel driving signal corresponding to the second original signal, a third sub-pixel driving signal corresponding to the third original signal and a fourth sub-pixel driving signal, the first original signal, the second original signal and the third original signal of one set of original signals being unequal to zero, the first original signal and the second original signal of the set of original signals being respectively identical to the first original signal and the second original signal of the other one set of original signals in the signal transforming table, the third original signal of the set of original signals being more than a second predetermined value, and the third sub-pixel driving signal of one set of pixel driving signals corresponding to the set of original signals being either more than or equal to the third original signal of the set of original signals;
a look-up module for finding at least one set of original signals being the same with the at least one set of input signals in the signal transforming table;
a signal output module for outputting at least one set of pixel driving signals corresponding to the at least one set of original signals; and
a driving module for driving at least one of the pixels of the pixel array with the at least one set of pixel driving signals.

20. A display device, comprising:
a pixel array comprising a plurality of pixels, each of the pixels comprising a plurality of sub-pixels;
a signal receiving module for receiving at least one set of input signals;
a storage module for storing a signal transforming table, the signal transforming table comprising a plurality of sets of original signals and a plurality of sets of pixel driving signals, each set of original signals corresponding to one set of pixel driving signals and comprising a first original signal, a second original signal and a third original signal, the corresponding one set of pixel driving signal comprising a first sub-pixel driving signal corresponding to the first original signal, a second sub-pixel driving signal corresponding to the second original signal, a third sub-pixel driving signal corresponding to the third original signal and a fourth sub-pixel driving signal, the first original signal, the second original signal and the third original signal of one set of original signals being unequal to zero, the first original signal and the second original signal of the set of original signals being respectively identical to the first original signal and the second original signal of the other one set of original signals in the signal transforming table, the third original signal of the set of original signals being less than a second predetermined value, and the third sub-pixel driving signal of one set of pixel driving signals corresponding to the set of original signals being either less than or equal to the third original signal of the set of original signals;
a look-up module for finding at least one set of original signals being the same with the at least one set of input signals in the signal transforming table;
a signal output module for outputting at least one set of pixel driving signals corresponding to the at least one set of original signals; and
a driving module for driving at least one of the pixels of the pixel array with the at least one set of pixel driving signals.
